(19) United States
(12) Patent Application Publication
(10) Pub. No.: US 2024/0172119 A1
(43) Pub. Date: May 23, 2024

(54) METHOD AND SYSTEM FOR XR SPECIFIC UE POWER SAVING FOR 5G NR.

(71) Applicant: THE INDIAN INSTITUTE OF TECHNOLOGY KHARAGPUR, Kharagpur (IN)

(72) Inventors: Sourav Dutta, Kharagpur (IN); Dibbendu Roy, Kharagpur (IN); Goutam Das, Kharagpur (IN)

(21) Appl. No.: 18/378,718

(22) Filed: Oct. 11, 2023

(30) Foreign Application Priority Data
Oct. 18, 2022 (IN) 202231059571

(51) Int. Cl. H04W 52/02; H04W 76/27; H04W 76/28

(52) U.S. Cl. CPC H04W 52/0235; H04W 76/27; H04W 76/28

(57) ABSTRACT

The present invention discloses a system for controlling periodical switching of XR devices or components thereof of an UE in 5G NR communication comprising a control unit for said 5G NR communication involving a gNB and said UE, wherein the control unit further includes a resource control module (RRC) for the UE which communicates with RRC of the gNB facilitating the UE to change its media access control and a XR-specific C-DRX module for XR-specific enhancement including enabling the XR devices or components thereof to select best possible sleep mode from different sleep modes as a function of sleep duration for maximizing UE power savings.

### CROSS-REFERENCE TO RELATED APPLICATION

This application is based on international Indian patent application PJ202231059571 filed on Oct. 18, 2022, the entire disclosures of which are incorporated herein by way of reference.

### FIELD OF THE INVENTION

The present invention relates to UE (User Equipment) power savings in 5G New Radio (NR) applications. More specifically, the present invention is directed to XR (Extended Reality) specific enhancement of C-DRX method and a system thereof for the UE power savings. For XR devices, the traffic pattern has been observed to be of Quasi-periodic nature having non-integer periods along with jitter around its mean arrival instant. This traffic nature is exploited in this invention for skipping some of the WUS (wake-up signal) messages. This results an increment of sleep duration of the XR devices or components thereof, which allows employing better energy-efficient sleep modes for improving energy efficiency.

### BACKGROUND OF THE INVENTION

Connected mode Discontinuous Reception (C-DRX) is a method of saving UE power by allowing the UEs to periodically enter into a sleep mode. During sleep mode, PDCCH (downlink control channel) monitoring is not performed and hence, no data transmission takes place. In order to monitor PDCCH for possible data transmission, the UE is allowed to periodically wake up from the sleep mode and stay ‘awake’ (On duration) for a certain duration before entering sleep mode once again. This entire cycle of periodic sleeping and awaking state is called the long DRX cycle. Based on the components that are switched-off, different ‘sleep modes’ with different power consumption figure and transition time are present: Micro-sleep, Light-sleep, and Deep-sleep. A UE that supports extended reality (XR) application is termed as XR device. Moreover, XR devices are wireless and hence are power hungry. Additionally, XR applications require high data rates, high transmission reliability and low latency. Thus, it is important to design energy efficient XR device while satisfying the mentioned requirements.

For implementing the existing C-DRX method in the XR devices, to monitor PDCCH, the XR devices need to wake-up periodically, and stay awake for a certain time before sleeping again. However, due to the high data rate and low latency requirements of XR, C-DRX cycles (time interval between two consecutive switch-on instances) should be very short. This results in low power saving figures, which is not desirable for XR devices. The periodic nature of XR traffic arrivals may allow choosing a longer C-DRX cycle. However, this requires the UE wake-up to be aligned with the XR traffic arrivals. This alignment may not be possible because of the following reasons.

Non-integer XR traffic periodicity: The typical XR traffic arrival periodicities are multiple of 16.67 ms, while in current form, the C-DRX cycle time can be configured as multiples of 1 ms. Due to this mismatch, the UE wake-up will eventually be misaligned with the XR traffic arrivals.

Quasi-periodic XR traffic periodicity: Although XR video frames are periodically generated at application server, due to encoding, compressing, routing and other processing, a jitter is introduced to the traffic arrival time. Thus, XR traffic arrival at gNB is pseudo periodic, i.e., arrival time is still random due to jitter. To employ the C-DRX method in the current configuration for the XR traffic, the XR devices are required to be kept switched-on over the entire jitter period. This may result in wastage of power consumption.

From the above discussion, it is now clear that the C-DRX method in the current configuration is not appropriate for XR traffic, requiring XR-specific C-DRX enhancement. Few attempts have been reported for controlling the XR devices sleeping mode under C-DRX mechanism.

Dongru Li; Huazheng You; Wei Jiang; Xiaohang Chen; Chaojun Zeng; Xiaodong Sun [“Enhanced Power Saving Schemes for eXtended Reality,” 2021 IEEE 32nd Annual International Symposium on Personal, Indoor and Mobile Radio Communications (PIMRC), 2021, pp. 1-6, doi: 10.1109/PIMRC50174.2021.9569348.] proposed a method to circumvent the issue of non-integer periodicity of XR traffic by dynamically adjusting the slot-offset. They also proposed dense placement of wake-up signal (WUS) message to address the quasi-periodic XR traffic pattern.

Yuchul Kim; Hwan-Joon Kwon; Olufunmilola Awoniyi-Oteri; Prashanth Hande; Jay Kumar Sundararajan; Yeliz Tokgoz; Tao Luo; Kiran Mukkavilli; Tingfang Ji [“UE Power Saving Techniques for Extended Reality (XR) Services in 5G NR Systems,” 2021 IEEE 32nd Annual International Symposium on Personal, Indoor and Mobile Radio Communications (PIMRC), 2021, pp. 1-7, doi: 10.1109/PIMRC50174.2021.9569722.] discuss the issues with XR traffic pattern namely, non-integer periodicity and quasi-periodicity. Then they propose methods similar to above for addressing these issues. They also proposed introducing a low-power circuitry so that WUS messages can be received at the UE during sleep-mode.

Daniela Laselva; Laura L. Sanchez; Faranaz Sabouri-S; Qiyang Zhao; Jorma Kaikkonen; Lars Dalsgaard; Pasi Kinnunen [“UE Measurements Relaxation for UE Power Saving in 5G New Radio,” 2021 IEEE 94th Vehicular Technology Conference (VTC2021-Fall), 2021, pp. 1-6, doi: 10.1109/VTC2021-Fall52928.2021.9625488.] introduced a wake-up signal (WUS) message to improve energy savings by reducing unnecessary ON durations. WUS is sent just before a probable data arrival event which helps in tracking the randomness in the arrival process.

U.S. Ser. No. 17/218,991 propose separating out the configuration settings for communication in three different zones or categories based on various requirements like delay budget, bandwidth requirement, throughput etc.

U.S. Pat. No. 10,701,756 propose switching between short and long DRX cycles based on delay requirements.

U.S. Pat. No. 11,291,073 propose a technique to receive the WUS message without keeping all the receiver components of UE to be in ON state. They use beamforming technique to achieve this.

However, in the above state of art techniques, the power saving efficiency is restricted as a lot of unnecessary WUS messages are sent. Hence, there has been a need for an improvement in controlling the XR devices sleeping mode under C-DRX mechanism which can skip unnecessary WUS messages allowing XR devices to employ deep and light sleep modes for better power savings.

### OBJECT OF THE INVENTION

It is thus basic object of the present invention is to provide an XR specific C-DRX method and a system thereof for selective controlling of periodic sleeping and awaking state of the XR devices or components thereof for improving its energy efficiency.

Another object of the present invention is to provide an XR specific C-DRX method and a system thereof for selective controlling of periodic sleeping and awaking state of the XR devices or components thereof which would increase sleep duration of the XR devices or components thereof to employ better energy-efficient sleep modes and thereby improving energy efficiency.

Yet another object of the present invention is to provide an XR specific C-DRX method and a system thereof for selective controlling of periodic sleeping and awaking state of the XR devices or components thereof which would exploit quasi-periodic traffic pattern of the XR devices for skipping unnecessary WUS messages and allowing XR devices to employ deep and light sleep modes for better power savings.

### SUMMARY OF THE INVENTION

Thus, according to the basic aspect of the present invention, there is provided a system for controlling periodical switching of XR devices or components thereof of an UE in 5G NR communication comprising
control unit for said 5G NR communication involving gNB and said UE;
said control unit includes
a radio resource control (RRC) for the UE which communicates with RRC of the gNB facilitating the UE to change its media access control; and
a XR-specific C-DRX module for XR-specific enhancement including enabling the XR devices or components thereof to select best possible sleep mode from different sleep modes as a function of sleep duration for maximizing UE power savings.

In a preferred embodiment of the present system, the gNB RRC includes configurable field drx-method-indicator which indicates whether the UE will operate in legacy C-DRX mode or in XR-C-DRX mode, whereby the UE RRC on receiving gNB RRC signal, operates either in legacy C-DRX mode or in XR-C-DRX mode as per the drx-method-indicator and parameter settings of the UE RRC are configured and implemented by the UE MAC C-DRX module.

In a preferred embodiment of the present system, the UE RRC on receiving gNB RRC signal waits till first ON duration and goes into state to receive WUS message at the beginning of long-DRX cycle, whereas on detecting WUS=0, the UE goes into micro-sleep mode and remains in said sleep-mode for a duration of drx-shortCycle, while detecting WUS=1, the UE goes into state to receive the WUS message during short cycle periods and checks for further WUS message;
wherein, on detecting further WUS=0, the UE goes into the micro-sleep mode and remains in said sleep-mode for the duration of drx-shortCycle and same process continues, otherwise, the UE goes into state to receive the XR frames and PDCCH from gNB MAC and resets the timer as drx-onDuration;
wherein the UE on receiving the PDCCH during the timer period, resets the timer by drx-InactivityTimer and process continues until timer expires and on expiry, the UE goes into represents mode selection state where the UE MAC C-DRX decide the sleep mode based on T_{sd};
wherein for any deep/light/micro sleep, the UE goes into ON state to receive WUS message on expiry of the drx-LongCycle.

In a preferred embodiment of the present system, the XR device is configured to periodically wake up to receive the WUS message until it receives the PDCCH message, and after receiving PDCCH, the XR device skips all WUS messages till the ON period of the next long cycle.

In a preferred embodiment of the present system, the thresholds for deciding whether the UE should be in deep/light/micro sleep are determined based on the conditions:

Deep sleep mode is selected if sleep duration is more than T_{ds} and light sleep if sleep duration is between T_{ds} and Tₗₛ. Otherwise, micro sleep mode is chosen.

$${T}_{ls} = ( \frac{{E}_{t}^{ls} {2}^{- μ}}{{E}_{ps}^{mi} - {E}_{ps}^{ls}} , {T}_{t}^{ls} )$$

$${T}_{ds} = ( \frac{{E}_{t}^{ds} - {E}_{t}^{ls}}{{E}_{ps}^{ls} - {E}_{ps}^{ds}} {2}^{- μ} , {T}_{t}^{ds} )$$

where Eₚₛ^{ls} and Eₚₛ^{ds}Eₚₛ^{mi} indicate relative power consumption when light, deep and micro sleep are employed while Eₜ^{ls}, Eₜ^{ds} and Tₜ^{ls}, Tₜ^{ds} represent the transition power consumption and times between the sleep and ON states of light and deep sleep modes respectively.

According to a further aspect of the present invention there is provided a method for controlling periodical switching of XR devices or components thereof of the UE in 5G NR communication involving the above system comprising
configuring Radio Resource Control (RRC) message to enable said XR-specific enhancement; and
involving XR-specific enhancement in C-DRX mechanism enabling XR devices to employ different sleep modes including involving the XR device or the components thereof to select best possible sleep mode as a function of sleep duration for maximizing power savings.

In above method, configuring Radio Resource Control (RRC) message to enable said XR-specific enhancement includes involving drx-method-indicator in the gNB RRC for selectively operating the UE in legacy C-DRX mode or the XR-C-DRX mode as per the drx-method-indicator.

In above method, the XR-specific enhancement in C-DRX mechanism for operating the XR devices in different sleep modes and selecting best possible sleep mode as a function of sleep duration includes
involving the UE RRC to receive gNB RRC signal which enables the UE to wait till ON duration and then goes into state to receive WUS message at beginning of the long-DRX cycle;
detecting the WUS message, whereby on detecting WUS=0, the UE goes into micro-sleep mode and remains in said sleep-mode for the duration of drx-shortCycle, while on detecting WUS=1, the UE goes into state to receive further WUS messages during a short cycle period and checks for further WUS message.
detecting further WUS message, whereby on detecting further WUS=0, the UE goes into the micro-sleep mode and remains in said sleep-mode for a duration of drx-shortCycle and same process continues, otherwise, the UE goes into state to receive the XR frames and PDCCH from gNB MAC and resets the timer as drx-onDuration;
resetting timer by drx-InactivityTimer when the UE receives the PDCCH during the timer period and process continues until timer expires and on expiry, the UE goes into represents mode selection state where the UE MAC C-DRX decide the sleep mode based on T_{sd}.

In above method, thresholds for deciding whether UE should be in deep/light/micro sleep are determined by computing

$${T}_{ls} = ( \frac{{E}_{t}^{ls} {2}^{- μ}}{{E}_{ps}^{mi} - {E}_{ps}^{ls}} , {T}_{t}^{ls} )$$

$${T}_{ds} = ( \frac{{E}_{t}^{ds} - {E}_{t}^{ls}}{{E}_{ps}^{ls} - {E}_{ps}^{ds}} {2}^{- μ} , {T}_{t}^{ds} )$$

where Eₚₛ^{ls} and Eₚₛ^{ds}Eₚₛ^{mi} indicate relative power consumption when light, deep and micro sleep are employed while Eₜ^{ls}, Eₜ^{ds} and Tₜ^{ls}, Tₜ^{ds} represent the transition power consumption and times between the sleep and ON states of light and deep sleep modes respectively.

### BRIEF DESCRIPTION OF THE ACCOMPANYING DRAWINGS

FIG. 1 shows control protocol stack of a 5G NR communication system involving the gNB and UE.

FIG. 2 shows the timing diagram of the invention and the communication between gNB and UE for controlling the C-DRX mechanism.

FIG. 3 shows the invented state diagram for MAC C-DRX 520. The shaded states are newly invented states for enhanced power savings.

FIG. 4 shows existing state diagram for MAC C-DRX 520.

FIG. 5 shows average power consumption for different values of (a) Frame rate (with the fixed data rate of 30 Mbps) and (b) Data rate (with the fixed frame rate of 30 fps); (c) Average frame delay figure: WUS implies both proposed method and prior art.

### DETAILED DESCRIPTION OF THE INVENTION WITH REFERENCE TO THE ACCOMPANYING DRAWINGS

As discussed hereinbefore, to resolve the issue of quasi-periodicity of XR traffic, existing works have proposed dense placement of WUS to inform the XR device about the XR traffic arrival. The suggested periodicity of WUS message is 2-3 ms to satisfy low latency requirements. In order to detect the WUS message, frequent switching-on (every 2-3 ms) of the XR devices is required resulting in short sleep duration. As a result, employment of micro-sleep is the only feasible option, as transition time of light sleep (6 ms) is higher than WUS periodicity. However, micro-sleep provides the lowest power saving figure and hence, the achieved power saving figure of this proposal may significantly be improved. A significant enhancement in power saving can be achieved by employing sleep modes with a lower power consumption figure. This requires increment of sleep duration. One possible way to do this is by skipping some WUS messages, when there is no possibility of traffic arrivals. The present work proposes such a method of skipping unnecessary WUS messages including an XR-specific enhancement in the current C-DRX method to resolve the issue of quasi-periodic nature of XR traffic, configuring the Radio Resource Control (RRC) message to enable this enhancement and enabling XR devices to employ different sleep modes including involving an XR device to select the best possible sleep mode as a function of sleep duration for maximizing power savings.

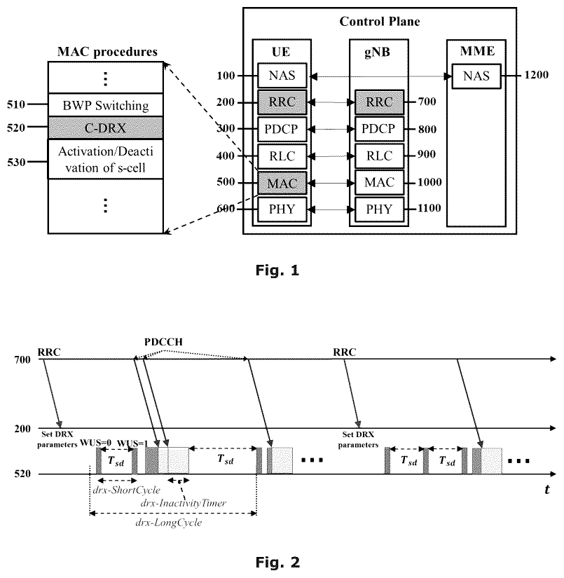

FIG. 1 shows the control unit of a 5G NR communication system involving the gNB and UE. In the context of control, present invention deals with the two modules of unit. 200 shows the radio resource control module (RRC) of the UE which communicates with the RRC of gNB 700. The RRC configuration helps the UE to change its media access control 500, where the present invention is to change the C-DRX module 520. The blue shades show the modules where the present invention is employed in 5G NR for XR energy savings.

As the XR frames are generated periodically, in order to employ the C-DRX method for power savings, the long DRX cycle is expected to be kept the same as the periodicity of XR traffic arrivals. Thus, the ON period of a DRX cycle starts at the k^{th} frame arrival time (denoted by T_{c}^{k}). However, due to encoding, compressing, routing and other processing, the k^{th} frame can arrive anywhere in between

$${T}_{o}^{k} - \frac{{T}_{j}}{2} and {T}_{o}^{k} + \frac{{T}_{j}}{2} ( {T}_{j} = Jitter Interval ) .$$

Thus, if a frame arrives at

$${T}_{c}^{k} - \frac{{T}_{j}}{2} ,$$

it will face at least Tⱼ/2 delay, which is not desirable for XR traffic due to its low latency requirement. To resolve this issue, the XR device needs to wake up at

$${T}_{c}^{k} - \frac{{T}_{j}}{2}$$

time to receive the k^{th} frame. This can be configured with the help of the ‘drx-LongCycleStartOffset’ and ‘drx-SlotOffset’ fields of the RRC message. Note that, the k^{th} frame can arrive at any time till

$${T}_{c}^{k} + \frac{{T}_{j}}{2} .$$

If the XR device enters into sleep mode before the frame arrival, then the frame needs to wait till the next DRX on period. This delay is also not desirable for XR traffic. Thus, to apply the C-DRX method in the current configuration for XR traffic, the ON timer should be chosen larger than Tⱼ. Thus, during this Tⱼ period, no energy savings is achieved, resulting in a poor power saving figure. Since this monitoring requires just one-bit information, the WUS message can be used for this purpose. Thus, a dense periodic placement of the WUS message can be used for this purpose. The periodicity of the WUS message can be informed to the XR device with the help of the ‘drx-ShortCycle’ field of the XR message. To employ this, the XR traffic needs to wake up frequently to receive the WUS message.

Note that, the k^{th} frame of the XR device arrives within

$${T}_{c}^{k} + \frac{{T}_{j}}{2} .$$

Thus, WUS message can be skipped after

$${T}_{c}^{k} + \frac{{T}_{j}}{2}$$

until the next Long cycle

$$( i . e . {T}_{c}^{k + 1} - \frac{{T}_{j}}{2} ) .$$

The number of WUS message within Tⱼ duration (denoted by N_{sc}) is Tⱼ/T_{sc}, where T_{sc} denotes short cycle time, configured by ‘drx-ShortCycle’ field of the RRC message. The centralized Base Band Unit (BBU pool) decides T_{sc}, depending on the latency requirement of XR devices. However, to employ skipping of WUS messages, the XR user needs to have the information of N_{sc}. Unfortunately, in the current C-DRX configuration, there is no scope for informing N_{sc} to the XR device, requiring an additional field in the RRC message.

Moreover, it can he noted that if the k^{th} frame of the XR device arrives before

$${T}_{c}^{k} = \frac{{T}_{j}}{2}$$

then it can be ensured that the next frame can arrive only after

$${T}_{c}^{k + 1} - \frac{{T}_{j}}{2} .$$

Thus, if the XR device receives a PDCCH message, it can skip all WUS messages till

$${T}_{c}^{k + 1} - \frac{{T}_{j}}{2} .$$

Therefore, the basic philosophy of the proposed enhanced C-DRX method is the followings:
An XR device periodically (configured by ‘drx-ShortCycle’) wakes up to receive a WUS message until it receives a PDCCH message.
After receiving PDCCH, the XR device skips all WUS messages till the ON period of the next long cycle.

The invented method as described above requires reconfiguration and modification of the existing RRC 700 which is shown below.

TABLE I

| Parameters | Configuration |
|---|---|
| drx-LongCycleStartOffset | Configure such that the long drx cycle starts |
| drx-SlotOffset | at the beginning of jitter interval |
| drx-LongCycle | Same as existing method |
| drx-onDuration | |
| drx-Inactivity Timer | |
| drx-ShortCycle | Set as interval between two consecutive |
| | WUS messages |
| drx-ShortCycle Timer | $[ \frac{jitter duration}{drx - ShortCycle} ]$ |
| drx-method-indicator | 0-Legacy C-DRX |
| | 1- Invented XR-C-DRX |

Table 1, shows the invention in configuration for RRC 700 where the invented new field termed drx-method-indicator indicates whether the UE operates in legacy C-DRX mode or the XR-C-DRX mode. The other existing fields that need to be modified are shown in Table I.

When the UE RRC 200 receives the gNB RRC 700 signal, it operates either in legacy mode or in the invented mode as specified by drx-method-indicator. The parameter settings of RRC 700 are configured and implemented by the UE MAC C-DRX module 520. The timing diagram of the invented C-DRX MAC is shown in FIG. 2.

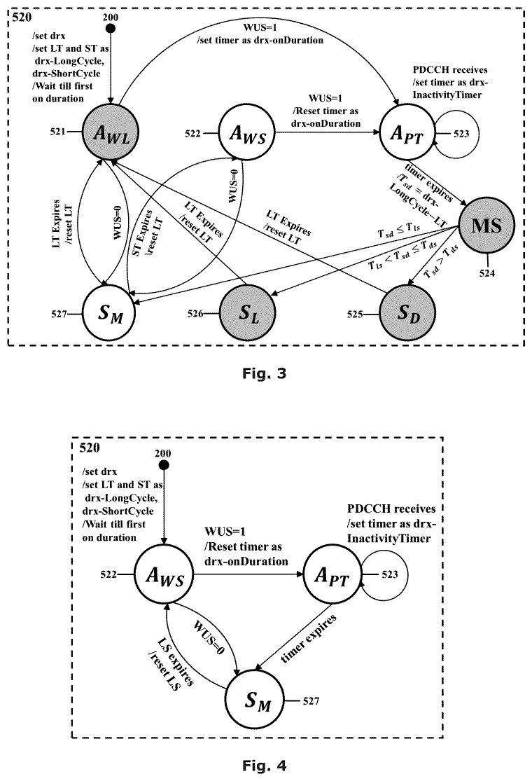

FIG. 2. shows the timing diagram of the invention and the communication between gNB and UE for controlling the C-DRX mechanism. 700 gNB RRC communicates with 200 UE RRC module. UE reads the RRC and sets the DRX parameters from the received RRC message. The invented method at MAC C-DRX 520 will be implemented as shown in FIG. 3.

FIG. 3 shows the invented state diagram for MAC C-DRX 520. The shaded states are newly invented states for enhanced power savings. 521, 522, 523 represent the active states (UE is ON). 521 is the ON state to receive WUS message at the beginning of long-DRX cycle. 522 is the ON state to receive the WUS message during short cycle periods. 523 is the ON state to receive the XR frames. 524 represents mode selection state where the UE MAC C-DRX 520 decides the optimal sleep-mode. 525, 526, 527 represent the sleep modes deep, light and micro sleep respectively. The state transitions are explained as follows:

UE receives RRC 700 at 200 and waits till first ON duration. Hence, it goes into state 521. When WUS=0, UE goes into micro-sleep 527 and remains in sleep-mode for a duration of drx-shortCycle. WUS=1, UE goes into state 522 and checks for WUS. If WUS=0, UE goes into state 527 and same process continues. Otherwise, UE goes into state 523 to receive PDCCH from gNB MAC 1000 and resets the timer as drx-onDuration. If it receives a PDCCH during the timer period, it resets the timer by drx-InactivityTimer and the process continues until timer expires. On expiry, UE goes into 524 to decide the sleep mode based on T_{sd}.

Let Eₚₛ^{ls} and Eₚₛ^{ds}Eₚₛ^{mi} indicate relative power consumption when light, deep and micro sleep are employed while Eₜ^{ls}, Eₜ^{ds} and Tₜ^{ls}, Tₜ^{ds} represent the transition power consumption and times between the sleep and ON states of light and deep sleep modes respectively. Then, we can calculate two thresholds for deciding whether UE should be in deep/light/micro sleep. Based on the conditions satisfied (shown in FIG. 4), the UE goes into state 525/526/527.

$${T}_{ls} = ( \frac{{E}_{t}^{ls} {2}^{- μ}}{{E}_{ps}^{mi} - {E}_{ps}^{ls}} , {T}_{t}^{ls} )$$

$${T}_{ds} = ( \frac{{E}_{t}^{ds} - {E}_{t}^{ls}}{{E}_{ps}^{ls} - {E}_{ps}^{ds}} {2}^{- μ} , {T}_{t}^{ds} )$$

From any of 525/526/527, the UE goes into 521 on expiry of drx-LongCycle.

The proposed invention has the following advantages:
Saves considerable UE power during XR sessions without additional hardware
Saving power reduces operational cost and hence cost-effective (Ref: Table II).

TABLE II

| Data Rate | Frame Rate | Maximum Relative |
|---|---|---|
| (Mbps) | (Fps) | power savings |
| 30 | 60 | 27% |
| 60 | 30 | 26% |
| 60 | 60 | 20% |

### Testing

Here, the performance of the proposed enhanced C-DRX method is evaluated with the help of emulation, performed in OMNET++ for a network run time of 200 s. Performance is evaluated in terms of average relative power consumption and average frame delay. These performance metrics have also been compared with the traditional C-DRX method and the existing proposals by Li and Kim for different values of frame rates (30 and 60 fps) and data rates (20 and 30 Mbps). It is assumed that present sleep mode selection process is employed in the case of legacy C-DRX. The relative energy consumption per slot (with respect to deep sleep), transition time, and energy are enlisted in Table III. The relative power consumption per slot of the active state is considered to be 100. The on timer and inactivity timer are assumed to be 2 ms and 4 ms respectively, while the periodicity of WUS messages is considered to be 2 ms. For wireless scheduling, we have considered Type 0 scheduling with a resource block group size of 8 and assumed that the best channel is scheduled first method. The value of μ is considered to be 2. The carrier frequency, wireless bandwidth, and maximum power of base station are assumed to be 4 GHz, 100 MHz, and 44 dBm respectively. The value of μ is assumed to be 2.

TABLE III

| Sleep | Relative | Transition | Transition Time |
|---|---|---|---|
| state | Power | Energy | (ms) |
| Micro | 45 | 0 | 0 |
| Light | 20 | 100 | 6 |
| Deep | 1 | 450 | 20 |

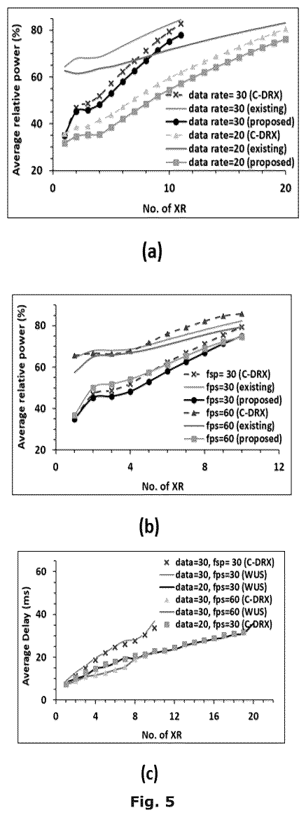

Effect of Frame rate: Here, the average relative energy consumption and average frame delay is compared for frame rates of 30 and 60 fps in FIG. 5(a) and (c). Note that, the proposed method skips those WUS messages when there is no possibility of XR traffic arrivals to improve energy efficiency. Thus, the average delay figure of both the proposed method and the method proposed by Li and Kim will exactly be the same. Thus, it is not plotted separately. FIG. 5(a) shows a significant improvement in energy efficiency as compared to both the existing method and the traditional C-DRX method without increasing the average delay significantly (refer FIG. 5(c)). Further, when frame rate decreases, this enhancement in power saving as compared to the method proposed by Li and Kim increases. This is due to the following fact: Decrement of frame rate increases the inter-frame time and hence, DRX cycle duration. Thus, the time interval between the finish of transmission of the current frame and the beginning of the next cycle increases. This is the duration over which our proposed method skips WUS messages, allowing the employment of better power efficient mode. Increment in this duration allows for employing a more power-efficient sleep mode, causing a better energy-efficiency figure. Another interesting observation is with the increment of frame rate, the increase in power savings of our proposed enhancement C-DRX method as compared to traditional C-DRX method enhances. The reason behind this can be explained as follows. As mentioned above, the DRX cycle duration decreases with the increment of frame rate, while the jitter duration remains the same. The proposed method provides the increment in power savings over the traditional C-DRX method, due to periodic micro sleep over jitter interval, instead of keeping the XR device on over this entire period. Decrement of DRX cycle duration, increases this effect causing an enhanced power saving figure. As the XR device is on over the entire jitter duration, the data transmission can be immediately started after its arrival, whereas in the proposed and the method proposed by Li and Kim, the XR frame needs to wait till the next WUS message, causing a slight increment in average delay. It can also be observed from FIG. 5(c) that average frame delay increases with the decrement of frame rate. This is due to the fact that the frame size increases with the decrement of frame rate while keeping the data rate the same, requiring a longer duration for the transmission of the frame.

Effect of data rate: Here, the average power consumption and average delay is compared for the data rate of each XR device of 20 and 30 Mbps in FIG. 5(b) and (c). It can be seen from FIG. 5(b) that the proposed method provides a significant improvement in energy efficiency as compared to both the method proposed by Li and Kim and the traditional C-DRX method even for different data rates. As expected, the lower data rate allows for supporting more XR devices. Moreover, decrement of data rate, while keeping the frame rate same, reduces the size of frames, requiring a shorter time to transmit the frame. This results in a decrement in average delay, as seen in FIG. 5(c).

We claim:

1. A system for controlling periodical switching of XR devices or components thereof of an UE in 5G NR communication comprising
control unit for said 5G NR communication involving gNB and said UE;
said control unit includes
a resource control module (RRC) for the UE which communicates with RRC of the gNB facilitating the UE to change its media access control; and
a XR-specific C-DRX module for XR-specific enhancement including enabling the XR devices or components thereof to select best possible sleep mode from different sleep modes as a function of sleep duration for maximizing UE power savings.

2. The system as claimed in claim 1, wherein the gNB RRC includes configurable field drx-method-indicator which indicates whether the UE will operate in legacy C-DRX mode or in XR-C-DRX mode, whereby the UE RRC on receiving gNB RRC signal, operates either in legacy C-DRX mode or in XR-C-DRX mode as per the drx-method-indicator and parameter settings of the UE RRC are configured and implemented by the UE MAC C-DRX module.

3. The system as claimed in claim 2, wherein the UE RRC on receiving gNB RRC signal waits till first ON duration and goes into state to receive WUS message at the beginning of long-DRX cycle, whereas on detecting WUS=0, the UE goes into micro-sleep mode and remains in said sleep-mode for a duration of drx-shortCycle, while detecting WUS=1, the UE goes into state to receive the WUS message during short cycle periods and checks for further WUS message;
wherein, on detecting further WUS=0, the UE goes into the micro-sleep mode and remains in said sleep-mode for the duration of drx-shortCycle and same process continues, otherwise, the UE goes into state to receive the XR frames and PDCCH from gNB MAC and resets the timer as drx-onDuration;
wherein the UE on receiving the PDCCH during the timer period, resets the timer by drx-InactivityTimer and process continues until tinier expires and on expiry, the UE goes into represents mode selection state where the UE MAC C-DRX decide the sleep mode based on T_{sd};
wherein for any deep/light/micro sleep, the UE goes into ON state to receive WUS message on expiry of the drx-LongCycle.

4. The system as claimed in claim 3, wherein the XR device is configured to periodically wakes up to receive the WUS message until it receives the PDCCH message, and after receiving PDCCH, the XR device skips all WUS messages till the ON period of the next long cycle.

5. The system as claimed in claim 1, wherein thresholds for deciding whether the UE should be in deep/light/micro sleep are determined based on the conditions:
$${T}_{ls} = ( \frac{{E}_{t}^{ls} {2}^{- μ}}{{E}_{ps}^{mi} - {E}_{ps}^{ls}} , {T}_{t}^{ls} )$$
$${T}_{ds} = ( \frac{{E}_{t}^{ds} - {E}_{t}^{ls}}{{E}_{ps}^{ls} - {E}_{ps}^{ds}} {2}^{- μ} , {T}_{t}^{ds} )$$
where Eₚₛ^{ls} and Eₚₛ^{ds}Eₚₛ^{mi} indicate relative power consumption when light, deep and micro sleep are employed while Eₜ^{ls}, Eₜ^{ds} and Tₜ^{ls}, Tₜ^{ds} represent the transition power consumption and times between the sleep and ON states of light and deep sleep modes respectively.

6. A method for controlling periodical switching of XR devices or components thereof of the UE in 5G NR communication involving the system as claimed in claim 1, comprising
configuring Radio Resource Control (RRC) message to enable said XR-specific enhancement; and
involving XR-specific enhancement in C-DRX mechanism enabling XR devices to employ different sleep modes including involving the XR device or the components thereof to select best possible sleep mode as a function of sleep duration for maximizing power savings.

7. The method as claimed in claim 6, wherein configuring Radio Resource Control (RRC) message to enable said XR-specific enhancement includes involving drx-method-indicator in the gNB RRC for selectively operating the UE in legacy C-DRX mode or the XR-C-DRX mode as per the drx-method-indicator.

8. The method as claimed in claim 7, wherein the XR-specific enhancement in C-DRX mechanism for operating the XR devices in different sleep modes and selecting best possible sleep mode as a function of sleep duration includes
involving the UE RRC to receive gNB RRC signal which enables the UE to wait till ON duration and then goes into state to receive WUS message at beginning of the long-DRX cycle;
detecting the WUS message, whereby on detecting WUS=0, the UE goes into micro-sleep mode and remains in said sleep-mode for the duration of drx-shortCycle, while on detecting WUS=1, the UE goes into state to receive further WUS messages during a short cycle period and checks for further WUS message;
detecting further WUS message, whereby on detecting further WUS=0, the UE goes into the micro-sleep mode and remains in said sleep-mode for a duration of drx-shortCycle and same process continues, otherwise, the UE goes into state to receive the XR frames and PDCCH from gNB MAC and resets the timer as drx-onDuration;
resetting timer by drx-InactivityTimer when the UE receives the PDCCH during the timer period and process continues until timer expires and on expiry, the UE goes into represents mode selection state where the UE MAC C-DRX decide the sleep mode based on T_{sd}.

9. The method as claimed in claim 6, wherein thresholds for deciding whether UE should be in deep/light/micro sleep are determined by computing
$${T}_{ls} = ( \frac{{E}_{t}^{ls} {2}^{- μ}}{{E}_{ps}^{mi} - {E}_{ps}^{ls}} , {T}_{t}^{ls} )$$
$${T}_{ds} = ( \frac{{E}_{t}^{ds} - {E}_{t}^{ls}}{{E}_{ps}^{ls} - {E}_{ps}^{ds}} {2}^{- μ} , {T}_{t}^{ds} )$$
where Eₚₛ^{ls} and Eₚₛ^{ds}Eₚₛ^{mi} indicate relative power consumption when light, deep and micro sleep are employed while Eₜ^{ls}, Eₜ^{ds} and Tₜ^{ls}, Tₜ^{ds} represent the transition power consumption and times between the sleep and ON states of light and deep sleep modes respectively.
